(19) United States
(12) Patent Application Publication
(10) Pub. No.: US 2002/0186924 A1
(43) Pub. Date: Dec. 12, 2002

(54) Grating fabrication method and apparatus

(76) Inventors: Glenn E. Kohnke, Painted Post, NY (US); Michal Mlejnek, Painted Post, NY (US)

Correspondence Address: CORNING INCORPORATED, SP-TI-3-1, CORNING, NY, 14831

(21) Appl. No.: 09/791,506

(22) Filed: Feb. 22, 2001

(51) Int. Cl. G02B 6/34

(52) U.S. Cl. 385/37; 430/5; 430/290

(57) ABSTRACT

The present relates to a method of changing the index of refraction of a optical fiber waveguide having a photosensitive core region fiber. The method includes providing a laser beam having a wavelength that will interact with the photosensitive core to change the index of refraction of the photosensitive core. The method uses a shadow mask and a lens. The lens is positioned to direct the portion of the laser beam passing through and the opening in the shadow mask onto the photosensitive core region of the optical waveguide fiber.

### BACKGROUND OF THE INVENTION

1. Field of the Invention

The present invention relates generally to the fabrication of diffractive gratings, and particularly to a method for fabricating apodized and chirped diffractive gratings.

2. Technical Background

The first order Bragg condition is given by equation 1:

λ_{B}=2n_{eff}Λ (1)

where

λ_{B} is the free space center wavelength of the input light that will be back reflected from the Bragg grating,

n_{eff} is the effective refractive index of the optical waveguide fiber core of the LP₀₁ mode at the free space center wavelength, and

Λ is the periodicity, or spacing, of the grating.

Apodization is a way of suppressing the side lobes in the reflection spectrum by gradually increasing the coupling coefficient with penetration into, as well as gradually decreasing on exiting from the grating. Apodized gratings find use in channel filtering of wavelength division multiplexed optical communication systems and dispersion compensation applications. Gratings that are solely apodized are used in channel filtering devices and enable decreased channel spacing. Gratings that are apodized and chirped are useful in the implementation of dispersion compensation in optical communication systems.

Chirp is a change in the grating wavelength λ_{B} as a function of length. A Bragg grating may be chirped is three ways. First by varying the periodicity, Λ, along the length of the grating while holding the effective index of refraction, n_{eff}, along the length of the grating constant. Secondly, a Bragg grating may be chirped by varying effective index of refraction, n_{eff}, along the length of the grating while holding the periodicity Λ the along the length of the grating constant. Thirdly, a Bragg grating may be chirped by varying both the effective index of refraction, n_{eff}, and the periodicity, Λ, along the length of the grating. Thus, equation 1 may be rewritten in a more general form as equation 2:

λ_{B}(X)=2n_{eff}(x)Λ(x) (2)

where

λ_{B}(X) is the free space center wavelength of the input light that will be back reflected from the Bragg grating as a function of distance along the length of the grating;

n_{eff}(x) is the effective refractive index of the optical waveguide fiber core of the LP₀₁ mode at the free space center wavelength as a function of distance along the length of the grating; and

Λ(x) is the periodicity, or spacing, of the the grating as a function of distance along the length of the grating.

Chirped fiber Bragg gratings find use in dispersion compensation in optical communication systems. Control of grating chirp is of interest in modifying the dispersion characteristics of the grating. Gratings with nonlinear chirp are of interest for some types of dispersion compensation applications.

In the case of UV-induced gratings, the grating strength is controlled as a function of length during UV exposure by using an exposure beam with a particular intensity profile, by scanning a smaller beam along the length of the grating or by scanning an aperture along a large beam. In any case, the strength of the grating changes as the product of the intensity and the exposure time.

There exists a need for a method of fabricating nonlinear gratings in optical waveguides. There also exists a need for a method of fabricating nonlinear gratings in optical waveguides that does not require a scanning laser beam technique. There also exists a need for a method of apodizing gratings.

### SUMMARY OF THE INVENTION

One aspect of the present invention is an apparatus for modifying the index of refraction of the core of an optical waveguide fiber. The apparatus includes a laser emitting a laser beam and a lens placed between the optical waveguide fiber and the laser. The apparatus further includes a shadow mask placed between the laser and the lens.

In another aspect, the present invention includes a method for writing a grating in an optical waveguide. The method includes the step of providing an optical waveguide having a photosensitive region. The method further includes the step of providing a laser beam having a rectangular cross section and a uniform energy density. The method further includes the step of providing a shadow mask, wherein the laser beam is incident to the shadow mask and the cross section of said laser beam is modified, producing a modified laser beam. The method further includes the step of providing a focusing lens disposed to receive the modified laser beam and focus the modified laser beam onto the photosensitive region of the optical waveguide whereby the index of refraction of the photosensitive region changes in proportion to the intensity of the modified laser beam focused onto the photosensitive region.

In another aspect, the present invention includes a method of changing the index of refraction of an optical waveguide fiber. The method includes the step of providing an optical waveguide fiber having a photosensitive core region disposed along the optical axis of the optical waveguide fiber. The method further includes the step of providing a laser beam having a wavelength that will interact with the photosensitive core and thereby changing the index of refraction of the photosensitive core. The method further includes the step of providing a shadow mask having an opening. The method further includes the step of providing a lens disposed between the shadow mask and the optical waveguide fiber. The method further includes the step of directing at least a portion of the laser beam through the opening. The method further includes the step of focusing the portion of the laser beam directed through the opening onto the photosensitive core region of the optical waveguide fiber using the lens. Whereby the portion of the laser beam directed through the opening induces a change in the refractive index of the core region.

In another aspect, the present invention includes a method of changing the index of refraction of the core of an optical waveguide fiber. The method includes the step of providing an optical waveguide fiber having a photosensitive core region disposed along the optical axis of the optical waveguide fiber. The method further includes the steps of providing a light source, providing a first shadow mask and providing a lens. The method further includes the step of aligning the light source, the first shadow mask, the lens and the photosensitive core region one to another so that the first shadow mask and the lens are disposed along the optical path of a beam of light emitted from the light source and directed onto the photo sensitive core region. The method further includes the step of altering the index of refraction of the photosensitive core region by directing a beam of light from the light source through the first shadow mask and into the lens. The lens directs the beam of light onto the photosensitive core region thereby inducing a change in the index of refraction of said photosensitive core region.

In another aspect, the present invention includes a method for writing a chirped Bragg grating in an optical waveguide fiber. The method includes the step of providing an optical waveguide fiber having a photosensitive core region disposed along the optical axis of the optical waveguide fiber. The method further includes the steps of providing a light source, providing a first shadow mask, and providing a lens. The method further includes the step of altering the index of refraction of the photosensitive core region by exposing the photosensitive core region to light from the light source. The light is directed onto the photosensitive core region by the lens after the light has passed through the first shadow mask and the photosensitive core region is exposed to the light for a predetermined time. The method further includes the steps of providing a second shadow mask and providing a phase mask. The method further includes the step of creating perturbations in the index of refraction of the photosensitive core region by exposing the photosensitive core region to light from the light source. The light is directed onto the photosensitive core region by the lens after the light has passed through the second shadow mask. After the light has passed through the lens the light passes through the phase mask and the photosensitive core region is exposed to the light for a predetermined time.

An advantage of the present invention is the improvement of the dispersion compensation characteristic of a chirped Bragg grating.

Another advantage of the present invention over prior art methods of grating fabrication is that no moving parts are required during the writing of the grating.

Another advantage of one embodiment of the present invention is that the laser beam, phase mask and photosensitive portion of the optical waveguide may remain stationary during the writing of the grating.

Another advantage of the present invention over prior art methods of apodizing a grating is that the present invention provides for a two exposure process that produces a constant average index of refraction along the length of the grating.

Another advantage of one embodiment of the present invention is that manufacture of apodized fiber Bragg gratings is simplified.

Another advantage of the present invention is that it can be used to produce apodized gratings.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a side view of an apparatus in which the present invention is embodied;

FIG. 2 is a perspective view of an optical fiber;

FIG. 3 is a side view of an apparatus in which the present invention is embodied;

FIG. 4 is a front view of a shadow mask;

FIG. 5 is a front view of a shadow mask;

FIG. 6 is a perspective view of an apparatus for modifying the index of refraction of the core of an optical waveguide fiber in which the present invention is embodied;

FIG. 7 is a perspective view of an apparatus for modifying the index of refraction of the core of an optical waveguide fiber in which the present invention is embodied;

FIG. 8 is a flowchart showing the process steps of one embodiment of the present invention in block diagram form;

FIG. 8A is a flowchart showing the process steps of one embodiment of the present invention in block diagram form;

FIG. 9 is a flowchart showing the process steps of one embodiment of the present invention in block diagram form;

FIG. 10 is a flowchart showing the process steps of one embodiment of the present invention in block diagram form;

FIG. 11 is a flowchart showing the process steps of one embodiment of the present invention in block diagram form;

FIG. 12 shows the transmission spectrum of a fiber Bragg grating made in accordance with an embodiment of the present invention; and

FIG. 13 is a shows the nonlinear group delay characteristic of a fiber Bragg grating made in accordance with an embodiment of the present invention.

### DETAILED DESCRIPTION OF THE PREFERRED EMBODIMENTS

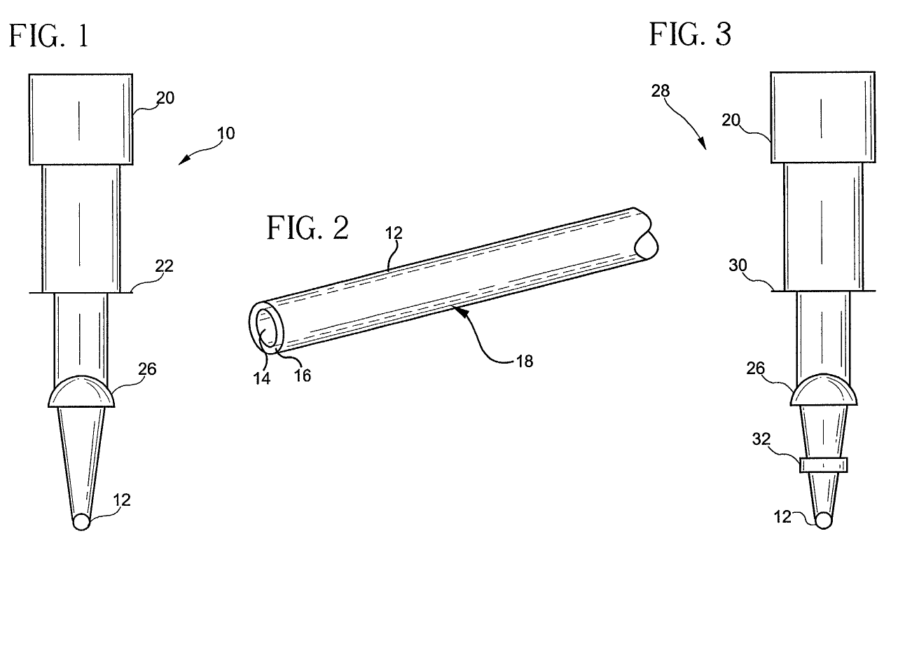

Reference will now be made in detail to the present preferred embodiments of the invention, examples of which are illustrated in the accompanying drawings. Wherever possible, the same reference numbers will be used throughout the drawings to refer to the same or like parts. An exemplary embodiment of the apparatus of the present invention is shown in FIG. 1, and is designated generally throughout by reference numeral 10.

The apparatus 10 of the present invention may be used to alter the index of refraction of an optical waveguide fiber 12. A typical optical waveguide fiber 12 in which a grating will be written is shown in FIG. 2. The optical waveguide fiber 12 includes a core 14 surrounded by a cladding 16. The core 14 includes a region 18 disposed along the optical axis of the optical waveguide fiber 12 that is photosensitive. That is to say the index of refraction of the region 18 may be altered by irradiating it with light of a certain wavelength, such as, for example by exposure to ultraviolet light.

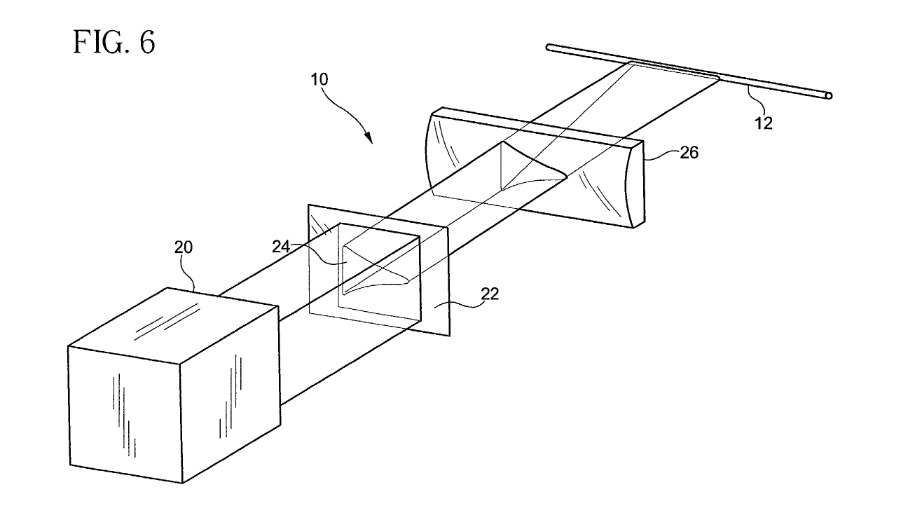

In accordance with the invention, the present invention for an apparatus 10 for fabricating gratings as embodied herein and depicted in FIG. 1 and FIG. 6 includes a light source 20. The light source 20 emits light that at a wavelength that will induce a change in the index of refraction in the photosensitive region 18 of the core 14.

The light source 20 may be a laser, such as, for example an excimer laser that emits a laser beam that is wider than the length of the grating to be written. Alternatively, the light source 20 may be a laser, such as, for example an excimer laser that emits a laser beam that is narrower than the length of the grating to be written. In the instance when the laser beam is less than the length of the desired grating the laser beam must be scanned along the length of the grating.

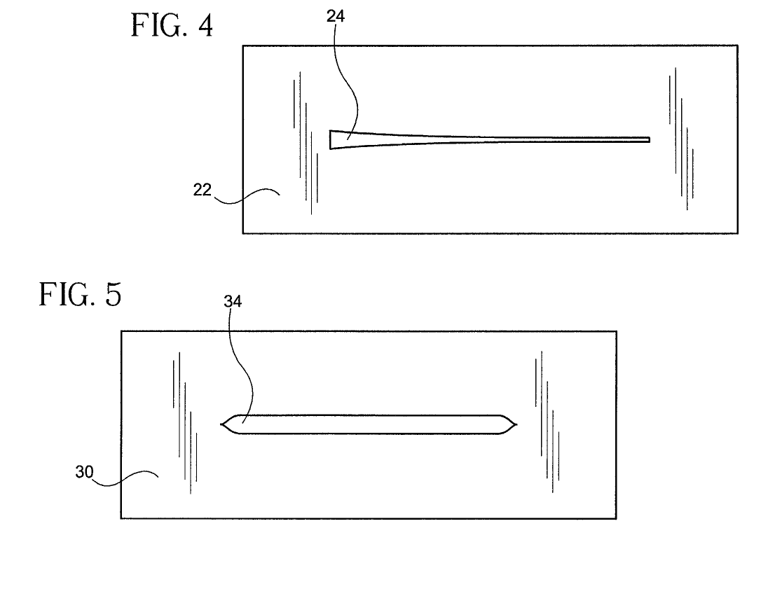

The apparatus 10 further includes a shadow mask 22. The shadow mask 22 is positioned between the light source 20 and the optical waveguide fiber 12. The shadow mask 22 includes an opening 24. The dimensions and shape of the opening 20 depend upon the intended result of using the shadow mask 22. Although the examples illustrated below and in the accompanying figures use shadow masks with vertically symmetric openings, the present invention is not limited to the use of shadow masks with vertically symmetric openings. In some instances, it may be advantageous to utilize a shadow mask with a non-vertically symmetric opening. For example, if the desired result is to alter the index of refraction of the core of the optical waveguide fiber in order to produce a nonlinearly chirped grating using a uniform phase mask the opening may be similar to that shown in FIG. 4.

The shadow mask 22 may be made from any material that allows an opening 24 to be adequately defined. For example, 0.005 inch stainless steel in which the opening 24 in the shadow mask 22 is made using photolithography to apply a mask to a shadow mask blank (not shown) and then etching the blank.

The shadow mask 22 may be aligned so that the opening 24 is vertically symmetric with respect to the longitudinal axis of the optical waveguide fiber 12. Additionally, the shadow mask 22 and its opening 24 may be rotated, tilted or offset with respect to the longitudinal axis of the optical waveguide fiber 12.

The apparatus 10 also includes a lens 26. The lens 26 focuses the laser beam in the vertical direction, directing the focused laser beam onto the optical waveguide fiber 12. The lens 26 may be, for example, a cylindrical lens.

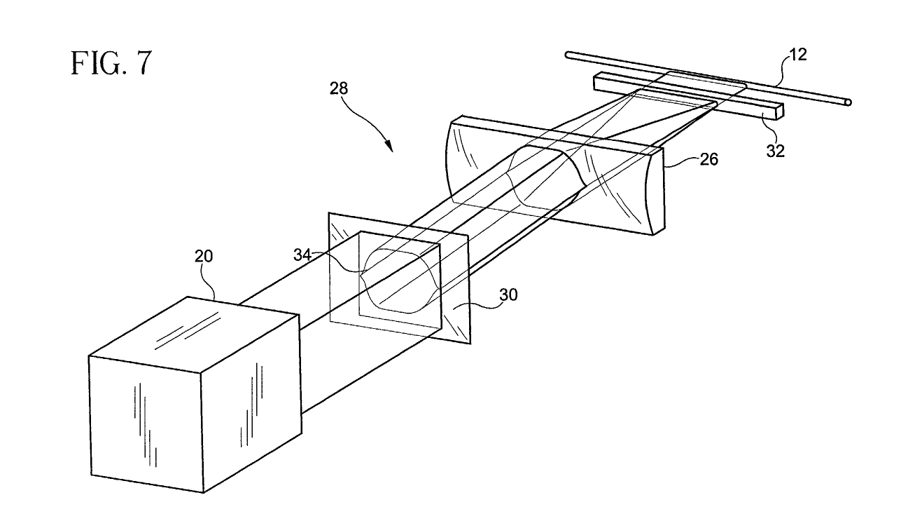

As embodied herein, and depicted in FIG. 3 and FIG. 7, the present invention includes an apparatus 28 for writing a grating in an optical fiber 12. The apparatus 28 includes light source 20, shadow mask 30, a lens 26 and a phase mask 32 may be either a chirped or uniform phase mask. Phase masks are readily available, one commercial source is Lasiris Inc. of St-Laurent, Quebec, Canada.

The optical fiber 12 includes a photosensitive core region having an index of refraction that changes with exposure to light of a certain wavelength. The light source 20, shadow mask 30, lens 26 and phase mask 32 are aligned so that light emitted from the light source is directed onto the optical waveguide fiber 12 after passing through the shadow mask 30, lens 26 and phase mask 32. The light emitted from the light source 20 includes light of a wavelength that induces a change in the index of refraction of the photosensitive core region of the optical waveguide fiber 12, thereby writing a grating in the optical waveguide fiber 12. Typically, the light source 20 emits a beam of light, such as, for example, a laser beam. The light beam may be of any cross-sectional shape, when the light source is an excimer laser, the light beam is typically rectangular in cross section. Preferably, the intensity of the light beam across the cross-section is uniform or near uniform.

The light source 20 may be a laser, such as, for example an excimer laser that emits a laser beam that is wider than the length of the grating to be written. Alternatively, the light source 20 may be a laser, such as, for example an excimer laser that emits a laser beam that is narrower than the length of the grating to be written. In the instance when the laser beam is less than the length of the desired grating the laser beam must be scanned along the length of the grating.

The shadow mask 30 includes an opening 34. The shadow mask 30 is positioned so that a portion of the light emitted is completely blocked from reaching the lens 26 while allowing a portion of the emitted light to reach the lens 26. The shadow mask 30 may be more filly described as either completely blocking a portion of the beam or completely transmitting a portion of the beam. The shadow mask 30 is sized so as not to require movement of the shadow mask relative to the optical fiber 12 during the exposure of the optical fiber 12 to the light beam. The dimensions and shape of the opening 34 depend upon the intended result of using the shadow mask 22. For example, if the desired result is to alter the index of refraction of the core of the optical waveguide fiber in order to produce an apodized grating using a uniform phase mask the opening may be similar to that shown in FIG. 5.

The shadow mask 30 may be made from any material that allows an opening 34 to be adequately defined. For example, 0.005 inch stainless steel in which the opening 34 in the shadow mask 30 is made using photolithography to apply a mask to a shadow mask blank (not shown) and then etching the blank.

The opening 34 in the shadow mask 30 is shaped to apodized the grating formed in the optical wave guide fiber 12. The shape of the opening 34 depends on the type of grating and the degree of apodization that is desired. Gaussian apodization, Super Gaussian apodization, Sinc apodization and Sinc² apodization index profiles have proven of interest in the field of optical communications systems.

The Gaussian apodization function has the functional form given by:

n(x)=e^{-(ax)}^{²} (3)

The Super Gaussian apodization function has the functional form given by:

n(x)=e^{-(ax)}^{ⁿ} (4)

The Sinc apodization function is given by:

$$n ( x ) = \frac{sin ( a π x )}{a π x} \qquad ( 5 )$$

The Sinc² apodization function is given by:

$$n ( x ) = {[ \frac{sin ( a π x )}{a π x} ]}^{2} \qquad ( 6 )$$

Super Gaussian apodization index profiles in which n is equal to 4, 6, or 24 have proven to be of particular interest.

The portion of the light beam not blocked by the shadow mask 30 is directed into the lens 26. The lens 26 focuses the light beam in the vertical direction, directing the focused laser beam onto the optical waveguide fiber 12. Preferably, the lens 26 focuses the light beam symmetrically about the axis of symmetry of the opening 34 in the shadow mask 30. The lens 26 may be, for example, a cylindrical lens.

The lens 26 directs the light beam through a phase mask 32 and onto the photosensitive core region of the optical fiber 12, thereby writing a grating in the optical fiber 12. The phase mask 32 may be either a chirped or uniform phase mask. Phase masks are readily available, one commercial source is Lasirislnc. of St-Laurent, Quebec, Canada. The use of phase mask to write gratings is well understood by those skilled in the art of gratings fabrication.

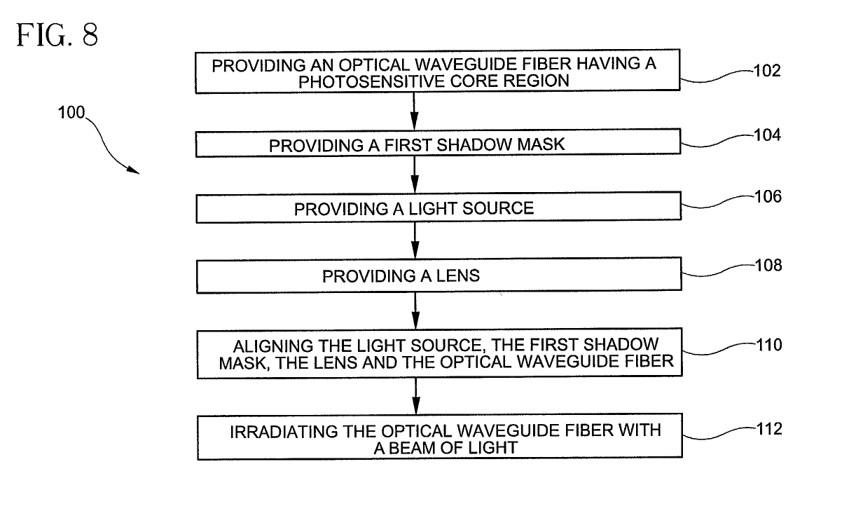

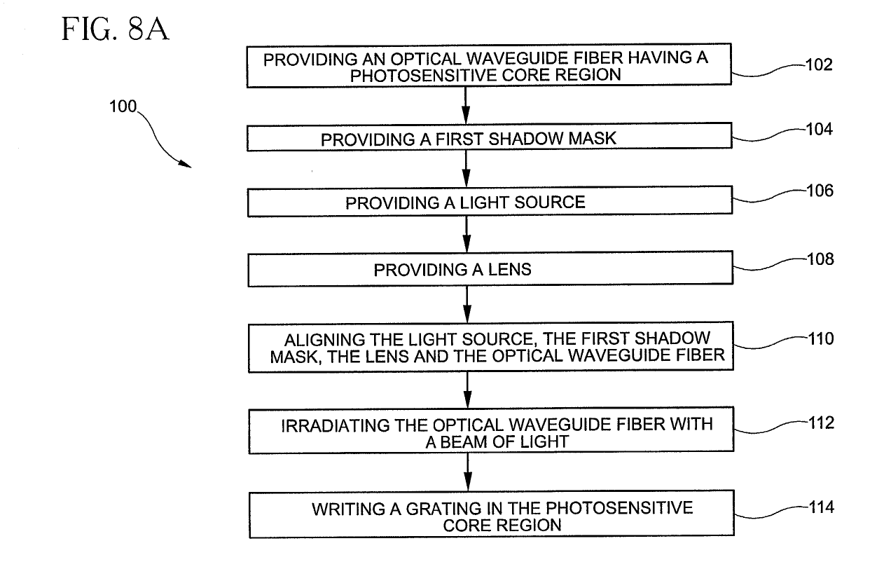

In an additional embodiment of the invention, as embodied herein and as shown in FIG. 8, the present invention includes a method 100 of altering the index of refraction of a photosensitive optical waveguide. The method 100 will be described with reference to FIGS. 1 and 3.

The method 100 includes the step 102 of providing an optical waveguide fiber having a longitudinal core region that is photosensitive, such as, for example a 2% Δ step index Germania doped optical fiber. The length of the photosensitive core region is at least as long as the length of the grating to be written.

The method 100 further includes the step 104 of providing a first shadow mask having an opening. The opening in the first shadow mask is a function of λ_{B}(X), the desired Bragg wavelength as a function along the length of the grating.

The opening in the shadow mask is proportional to the change in n_{eff}(x) relative to the baseline n_{eff}.

The desired Bragg wavelength variation along the grating length is given by

λ_{B}(x)=2·n_{eff}·Λₙₗ(x) (7)

where

λ_{B}(X) is the free space center wavelength of the input light that will be back reflected from the Bragg grating as a function of distance along the length of the grating,

n_{eff} is the effective refractive index of the optical waveguide fiber core of the LP₀₁ mode at the free space center wavelength, and

Λₙₗ(x) is the variation in grating period described by:

$${Λ}_{nl} ( x ) = {Λ}_{0} - Δ [ \sqrt{\frac{x}{L}} - \frac{1}{\sqrt{2}} ] \qquad ( 8 )$$

where

Λₒ is a constant reference period,

Δ is a scale factor proportional to the magnitude of the variation, and

L is the grating length.

In the example presented here, a combination of linearly chirped phase mask with nonlinear change in n_{eff} is required. The Bragg wavelength is then given by:

λ_{B}(X)=2·n_{eff}(X)·Λₗᵢₙ(x) (9)

where Λₗᵢₙ is given by:

$${{Λ}_{lin} ( x ) = {Λ}_{nl} ( L ) + \frac{ⅆ Λ}{ⅆ x} \vert}_{x = L} \cdot ( x - L ) \qquad ( 10 )$$

where the chirp of the grating period is

$${\frac{ⅆ Λ}{ⅆ x} \vert}_{x = L} ,$$

which is negative in this example.

Solving for the quantity (n_{eff}(x)−n_{eff}) using the two equations for λ_{B} above, the chirp mask height Chirp(x) is given by:

$$Chirp ( x ) ∝ {n}_{eff} \cdot ( \frac{{Λ}_{nl} ( x )}{{Λ}_{lin} ( x )} - 1 ) \qquad ( 11 )$$

This function is shown in FIG. 2 for Δ=0.0011 μm and Λₒ=0.5314 μm. In order to prevent the aperture of the phase mask from going to an unrealizable height of zero at an end, an offset parameter is introduced. The background refractive index profile required to obtain a nonlinearly chirped grating with a linearly chirped phase mask is given by:

$$Chirp ( x ) = {n}_{eff} \cdot ( \frac{{Λ}_{nl} ( x )}{{Λ}_{lin} ( x )} - 1 ) + Offset \qquad ( 12 )$$

An Offset value of 0.0002 is sufficient. To convert this function to an aperture height function, normalization is required.

$$Norm ( x ) = \frac{Chirp ( x )}{Chirp ( 0 )} \qquad ( 13 )$$

Preferably, the opening is vertically symmetric. The vertical symmetry of the opening in the first shadow mask simplifies alignment of the shadow light source 20, first shadow mask 22, lens 26 and optical waveguide fiber 12 as shown in FIG. 1.

The height of the aperture is given by multiplying Norm(x) by a scaling factor, SF, as shown in equation 14.

Height(x)=SF·Norm(x) (14)

To obtain a vertically symmetric aperture, this function is inverted to produce the lower half of the aperture. The height function is then given by half the maximum desired mask aperture multiplied by Norm(x). For example, when the maximum desired height of the aperture 24 is 6 mm and the scale factor is 3 mm, and the aperture height is given by equation 15.

Height(x)=(3 mm)Norm(x) (15)

This process assumes there is a linear relationship between aperture size and resulting index change. If this is not the case, the aperture height must be scaled by an additional factor incorporating the nonlinear dependence of index change on aperture height.

The method 100 further includes the step 106 of providing a light source 20. The light source 20 emits a beam of light at a wavelength that will induce a change in the index of refraction in the photosensitive region 18 of the core 14. When the index of refraction of the photosensitive core region of the optical waveguide fiber changes with exposure to ultraviolet light, the light source 20 is typically a laser, such as, for example an excimer laser, that emits a beam of ultraviolet light.

The method 100 further includes the step 108 of providing a lens 26 capable of collapsing a beam of light in a single direction perpendicular to the direction the beam of light is propagating in, such as, for example a cylindrical lens. As shown in FIG. 1, the lens 26 is used to focus the beam vertically with respect to the longitudinal axis of the optical waveguide fiber 12.

The method 100 further includes the step 110 of aligning the light source 20, the first shadow mask 22, the lens 26 and the optical waveguide fiber 12. The light source 20, the first shadow mask 22 and lens 26 are aligned with one another and the optical waveguide fiber 12 so that a beam of light emitted from the light source 20 will strike the photosensitive core region of the optical waveguide fiber 12 after passing through the first shadow mask 22 and the lens 26.

The first shadow mask 22 is positioned so that the axis of vertical symmetry of the opening 24 and the longitudinal axis of the optical waveguide fiber 12 lie in a common plane.

The lens 26 is positioned to receive the beam of light after it has passed through the first shadow mask 22. The lens 26 is concurrently positioned to focus the beam of light perpendicular to the plane defined by the longitudinal axis of the optical waveguide fiber 12 and the axis of vertical symmetry of the opening 24 in the first shadow mask 22.

The method 100 further includes the step 112 of exposing the photosensitive core region of the optical waveguide fiber 12 to a beam of light from the light source 20 to alter the index of refraction of the photosensitive core region by a predetermined, nonlinear amount along the longitudinal axis of optical waveguide fiber 12.

By exposing the fiber without the phase mask in place and using a first shadow mask 22 having a vertically symmetric opening 24, a grating formed using a linearly chirped phase mask will have the correct Bragg wavelength variation. Depending on the value of A, there may or may not be enough index change available to produce the nonlinear Bragg wavelength with an unchirped phase mask.

Turning to FIG. 8A, in an alternative embodiment, the method 100 includes a two exposure process is that creates an apodized grating with a square root dependence of Bragg wavelength, λ_{B}, as a function of length. The method 100 further includes the step 114 of writing a grating into the photosensitive core region of the optical waveguide fiber. The step 114 of the method 100 may be better understood by referring to FIG. 3 that shows an apparatus embodiment of the present invention for use in forming a grating in a photosensitive core region of an optical waveguide fiber.

The method 100 is one method of making a nonlinearly chirped fiber Bragg grating in which the present invention is embodied. The method 100 includes using a linearly chirped phase mask. Linearly chirped phase masks are commercially available while at the current time nonlinearly chirped phase masks are not. Therefore, the method 100 will be described in terms of using a linearly chirped phase mask. Because the method 100 uses a linearly chirped phase mask it is necessary to vary n_{eff} to obtain the nonlinear change in Bragg wavelength of the grating.

It will be apparent to those skilled in the art that modifications and variations may be made to the method 100 of the present invention, such as, for example replacing the linearly chirped phase mask with either a phase mask having uniform periodicity or a nonlinearly chirped phase mask.

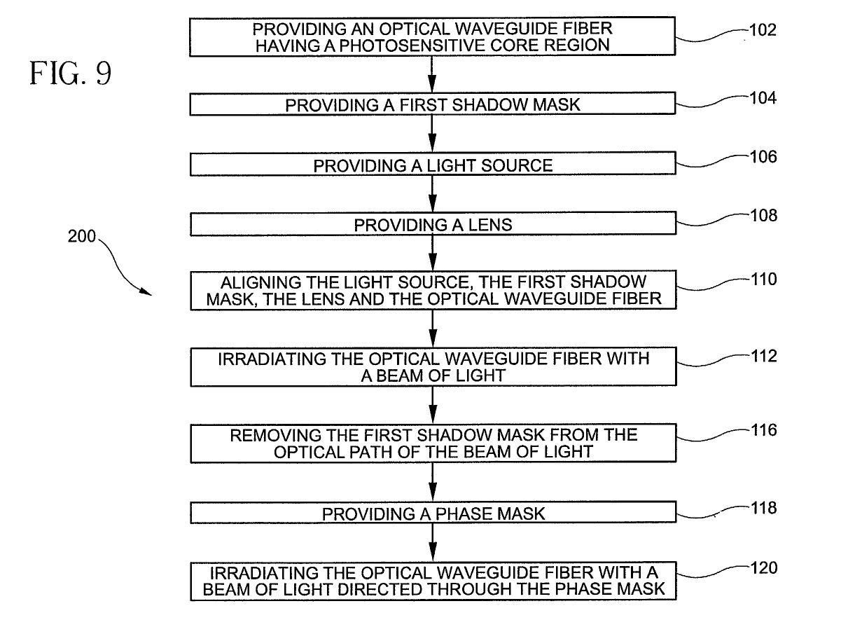

In an additional embodiment of the invention, as embodied herein and as shown in FIG. 9, the present invention includes a method 200 for making fiber Bragg gratings. The method 200 includes a two exposure process that creates a grating with a square root dependence of Bragg wavelength, λ_{B}, as a function of length. The method 200 will be described with reference to FIGS. 1 and 3.

The method 200 for forming fiber Bragg gratings includes the same steps 102, 104, 106, 108, 110, and 112 as the method 100 for making fiber Bragg gratings previously described as well as further including the step 116 of removing the first shadow mask 22 from the optical path of the beam of light, the step 118 of providing a phase mask 32 and the step 120 irradiating the photosensitive core region 18 with a beam of light emitted from the light source 20 directed through the phase mask 32.

The method 200 includes the step 116 of removing the first shadow mask 22 from the path of the light beam emitted by the light source 20.

The method 200 includes the step 118 of providing a phase mask 32. The phase mask 32 is placed between the lens 26 and the optical waveguide fiber 12. The phase mask 32 is positioned so that the focused beam from the lens 26 is directed through the phase mask 32 before impinging on the photosensitive core region of the optical waveguide fiber 12.

The method 200 further includes the step 118 of irradiating the photosensitive core region of the optical waveguide fiber 12 that was previously irradiated by a beam of light from the light source 20. As previously noted the phase mask is positioned between the lens 26 and the optical waveguide fiber 12. The phase mask 32 causes the light to set up an interference pattern. The light in the interference pattern induces the discrete changes in the photosensitive core region along the longitudinal axis of the optical waveguide fiber 12. The periodicity of the discrete changes in the index of refraction of the photosensitive core region corresponds to the bright spots in the interference pattern.

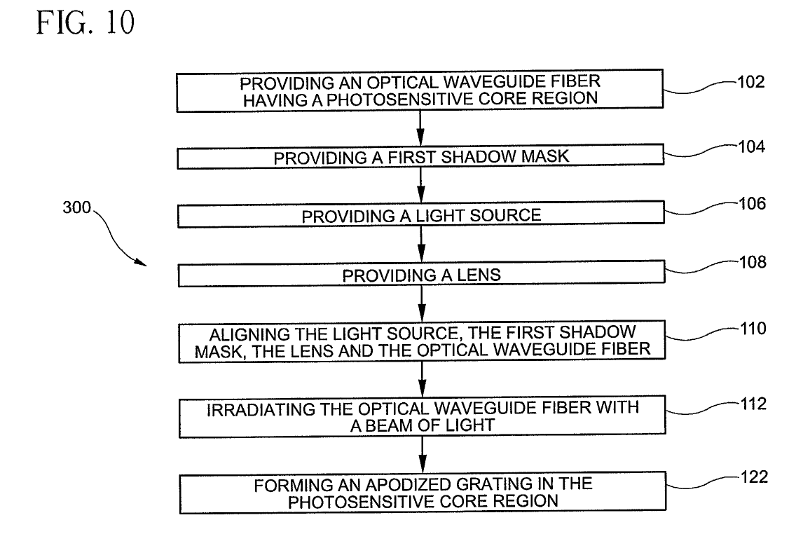

In dispersion compensation applications, the grating group delay ripple is minimized by apodizing the grating. Accordingly, in an additional embodiment of the invention, as embodied herein and as shown in FIG. 10, the present invention includes a method 300 for making apodized fiber Bragg gratings. The method 300 will be described with reference to FIGS. 1 and 3.

The method 300 for forming fiber Bragg gratings includes the same steps 102, 104, 106, 108, 110, and 112 as the method 100 for making fiber Bragg gratings previously described.

The method 300 further includes the step 122 of forming an apodized grating in the photosensitive core region 18.

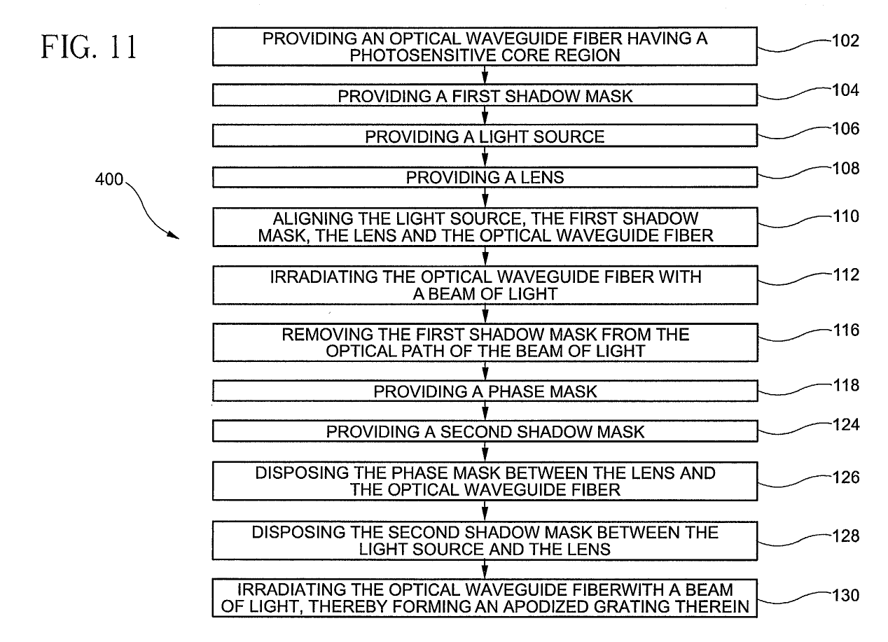

In an additional embodiment of the invention, as embodied herein and as shown in FIG. 11, the present invention includes a method 400 for making apodized fiber Bragg gratings. The method 400 will be described with reference to FIGS. 1 and 3.

The method 400 for making apodized fiber Bragg gratings includes the same steps 102, 104, 106, 108, 110, and 112 as the method 100 for making fiber Bragg gratings previously described.

The method 400 for making apodized fiber Bragg gratings further includes the step 116 of removing the first shadow mask 22 from the optical path of the light beam emitted by the light source 20.

The method 400 for making apodized fiber Bragg gratings further includes the step 118 of providing a phase mask 32.

The method 400 for making apodized fiber Bragg gratings further includes the step 118 of disposing the phase mask 32 between the lens 26 and the optical waveguide fiber 12. The phase mask 32 is positioned so that the focused beam from the lens 26 is directed through the phase mask 32 thereby forming an optical interference pattern on the photosensitive core region of the optical waveguide fiber 12.

The method 400 for making apodized fiber Bragg gratings further includes the step 122 of providing a second shadow mask 30. The second shadow mask 30 includes a opening 34 that is vertically symmetric. The shape of the opening depends upon the shape of the opening 24 of the first shadow mask 22 used in the step 112 of exposing the photosensitive core region of the optical waveguide fiber 12 to a beam of light from the light source 20.

For the chirp function presented above, equation 15, a higher-order Gaussian apodization functions work well to reduce group delay ripple. The functional form of the apodization using a 24th order Gaussian is given by:

$$Apodization ( x ) = {ⅇ}^{- {[ \frac{2 ( x - {x}_{m} )}{0.9 \cdot L} ]}^{24}} \qquad ( 16 )$$

where

x is the distance from one end of the grating to be formed towards the other end of the grating to be formed as measured along the length of the optical waveguide fiber,

xₘ is the distance from one end of the grating to be formed to the center of the grating to be formed as measured along the length of the optical waveguide fiber, and

L is the length of the grating to be formed.

It should be noted that equation 16 has been normalized to unity. The actual size of the vertical dimension is dependent on the laser system and the optical system being used.

The second shadow mask 30 defines an opening corresponding to Apodization(x) of equation 16 mirrored about a horizontal axis, thereby forming a vertically symmetric opening.

The method 400 for making apodized fiber Bragg gratings further includes the step 126 of positioning the second shadow mask 30 between the light source 20 and the lens 26 so that the axis of vertical symmetry of the opening of the second shadow mask 30 lies in the plane previously defined by the axis of vertical symmetry of the opening 24 of the first shadow mask 22 and the longitudinal axis of the optical waveguide fiber 12 in step 110.

The method 400 for making apodized fiber Bragg gratings further includes the step 130 of irradiating the photosensitive core region of the optical waveguide fiber 12 that was previously irradiated by the light source 20 in step 112. The phase mask 32 positioned between the lens 26 and the optical waveguide fiber 12 causes the light to set up an interference pattern. The light in the interference pattern induces the discrete changes in the photosensitive core region along the longitudinal axis of the optical waveguide fiber 12. The periodicity of the discrete changes in the index of refraction of the photosensitive core region corresponds to the bright spots in the interference pattern.

### EXAMPLE

The invention will be further clarified by the following examples which are intended to be exemplary of the invention.

In this example, the shadow masks are used with an expanded excimer laser beam to form an apodized, nonlinear fiber Bragg grating. The optical waveguide fiber 12 is a 2% Δ step index Germania doped optical fiber. The desired grating length is 100 mm. In the first exposure, the system was configured as shown in FIG. 1. The light source 20 is an excimer laser, in particular a Lambda Physik LPX 205i with a Nova Tube Upgrade, available from Lambda Physik, Incorporated. The beam of the laser 20 is expanded so that it is 100 mm wide×10 mm high when it is incident on the first shadow mask 22. The opening 24 in the first shadow mask is defined according to equation 15, the opening 24 has a maximum vertical aperture of 6 mm, the length of the opening 24 is 100 mm. The first shadow mask is made from stainless steel having a thickness of 0.005 inch The first shadow mask 22 is located 313 cm from the excimer laser.

The beam is then focused onto the fiber 12 using a cylindrical lens 26. The cylindrical lens 26 is located 290 mm from the first shadow mask 22. The beam is then focused onto the fiber 12 using the cylindrical lens 26. The optical waveguide fiber 12 is placed 222 mm from the lens 26.

The excimer laser 26 and cylindrical lens 26 are configured to provide an energy density per pulse at the fiber of about 125 mJ/cm².

The excimer laser was run at a repetition rate of 20 Hz and the fiber was exposed for 4.5 minutes.

During the second exposure, the system was configured as shown in FIG. 3. The first shadow mask 22 was removed and a second shadow mask 30 was placed between the excimer laser and the lens 26. The opening 34 in the first shadow mask is defined according to equation 16, the opening 34 has a maximum vertical aperture of 6 mm, the length of the opening 24 is 100 mm. The second shadow mask 30 is made from stainless steel having a thickness of 0.005 inch. The second shadow mask 30 is located 313 cm from the excimer laser.

A phase mask 30 is placed between the cylindrical lens 26 and the optical waveguide fiber 12. The phase mask 30 used in this example had an aperture of 10 mm×120 mm, a period of 1.06512μm and a chirp of 0.114 nm/cm. The phase mask 30 is placed 220 mm from the cylindrical lens 26. The optical waveguide fiber 12 is placed 0.5 mm from the phase mask 30.

The cylindrical lens 26 is located 290 mm from the first shadow mask 22.

The excimer laser 20 was run at a repetition rate of 10 Hz and the optical waveguide fiber 12 was exposed for 1.5 minutes.

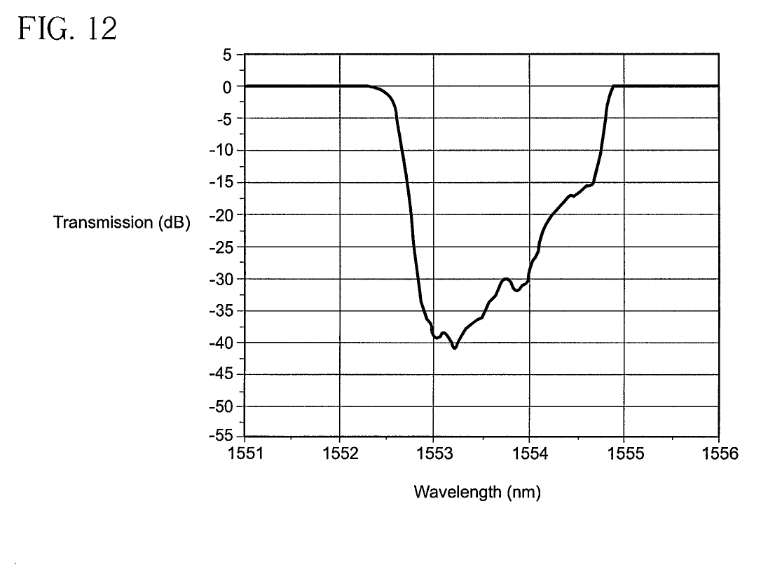

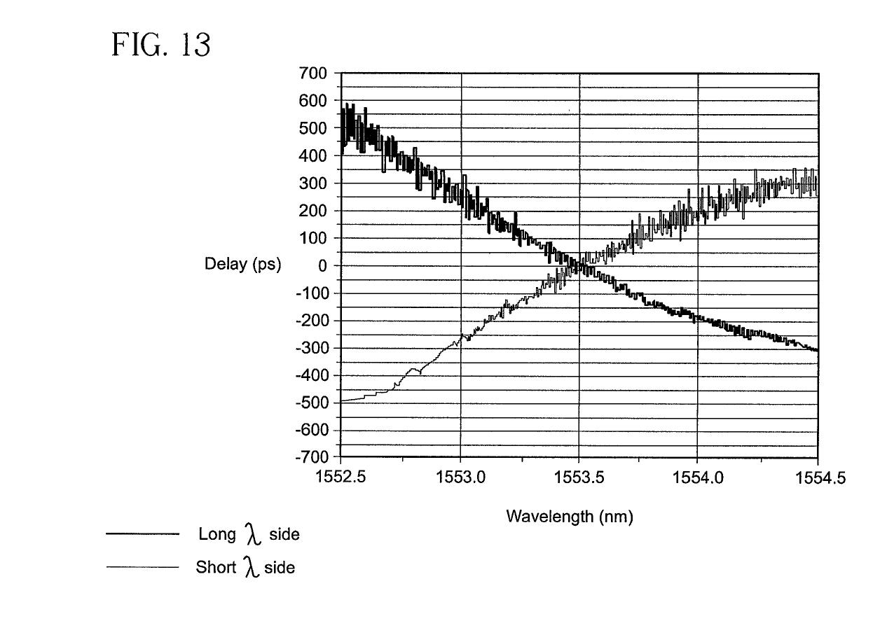

The transmission spectrum of the grating is shown in FIG. 12. FIG. 13 shows the nonlinear group delay characteristic of the grating. The nonlinearity is a consequence of having a nonlinear change in Bragg wavelength along the grating length. The Long λ side refers to portion of the Bragg grating where the Bragg wavelength, λ_{B}, is longest and the light propagating towards the grating encounters this portion first. The Short λ side refers to portion of the Bragg grating where the Bragg wavelength, λ_{B}, is shortest and the light propagating towards the grating encounters this portion first.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

Although the description above refers to optical waveguide fibers it will be apparent to those skilled in the art of making gratings in optical waveguides that the methods and apparatus of the present invention are readily adaptable for use with planar waveguides. Furthermore, it will be apparent to those skilled in the art of making gratings in optical waveguides that the methods and apparatus of the present invention are not limited to glass optical waveguides and are readily useable with polymer optical waveguides.

What is claimed is:

1. An apparatus for modifying the index of refraction of the core of an optical waveguide fiber comprising:
a laser emitting a laser beam;
a lens disposed between the optical waveguide fiber and said laser; and
a shadow mask disposed between said laser and said lens.

2. The apparatus of claim 1 wherein said lens is a cylindrical lens.

3. The apparatus of claim 2 wherein said shadow mask defines an opening.

4. The apparatus of claim 3 wherein said opening is symmetric about an axis.

5. The apparatus of claim 4 wherein said axis is coplanar with the optical axis of a portion of the optical waveguide fiber.

6. The apparatus of claim 2 wherein said laser beam has a uniform intensity.

7. The apparatus of claim 6 wherein the laser beam is rectangular in cross section.

8. The apparatus of claim 1 wherein said laser is an excimer laser.

9. The apparatus of claim 4 wherein said shadow mask is made from metal.

10. The apparatus of claim 9 wherein said shadow mask is made from stainless steel.

11. The apparatus of claim 4 wherein the vertical dimension of said opening varies nonlinearly along the length of said opening.

12. The apparatus of claim 1 further including a phase mask disposed between said lens and the optical waveguide fiber.

13. A method of changing the index of refraction of a optical fiber waveguide comprising the steps of:
providing an optical waveguide fiber having a photosensitive core region disposed along the optical axis of the optical waveguide fiber;
providing a laser beam having a wavelength that will interact with the photosensitive core thereby changing the index of refraction of the photosensitive core;
providing a shadow mask, wherein said shadow mask defines an opening;
providing a lens, wherein the lens is disposed between the shadow mask and the optical waveguide fiber;
directing at least a portion of the laser beam through the opening;
focusing the portion of the laser beam directed through the opening onto the photosensitive core region of the optical waveguide fiber using the lens, whereby the portion of the laser beam directed through the opening induces a change in the refractive index of the core region.

14. The method of claim 13 wherein the opening is defined so as to produce a nonlinear variation in the refractive index of the core direction along the optical axis of the optical waveguide fiber.

15. The method of claim 13 further comprising the step of:
providing a phase mask, wherein the phase mask is disposed between the lens and the photosensitive core region of the optical waveguide fiber and wherein at least part of the portion of the laser beam directed through the opening passes through the phase mask before striking said core.

16. The method of claim 15 wherein the phase mask is an unchirped phase mask.

17. The method of claim 15 wherein the phase mask is a linearly chirped phase mask.

18. The method of claim 15 wherein the phase mask is a nonlinearly chirped phase mask.

19. A method of changing the index of refraction of the core of an optical waveguide fiber comprising the steps of:
providing an optical waveguide fiber having a photosensitive core region disposed along the optical axis of the optical waveguide fiber;
providing a light source;
providing a first shadow mask;
providing a lens;
aligning the light source, the first shadow mask, the lens and the photosensitive core region one to another, so that the first shadow mask and the lens are disposed along the optical path of a beam of light emitted from the light source and directed onto the photo sensitive core region,
altering the index of refraction of the photosensitive core region by directing a beam of light emitted by the light source through the first shadow mask and into the lens, wherein the lens directs the beam of light onto the photosensitive core region thereby inducing a change in the index of refraction of said photosensitive core region.

20. The method of claim 19 further including the steps of:
removing the first shadow mask from the optical path;
providing a second shadow mask;
disposing the second shadow mask in the optical path between the light source and the lens, wherein said second shadow mask defines a second opening;
providing a phase mask;
disposing the phase mask between the lens and the photosensitive core region, wherein the phase mask is disposed so as to receive the beam of light from the lens; and
exposing the photosensitive core region to a beam of light emitted from the light source after the light beam has sequentially passed through the second shadow mask, lens and phase mask, thereby forming a grating in the photosensitive core region.

21. The method of claim 20 wherein the opening in the first shadow mask is vertically symmetric and one half of the height of the opening is given by the equation
$$Chirp ( x ) ∝ {n}_{eff} \cdot ( \frac{{Λ}_{nl} ( x )}{{Λ}_{lin} ( x )} - 1 ) .$$

22. The method of claim 21 wherein the second opening is a vertically symmetric opening, wherein the opening is a 24th order Gaussian distribution reflected about the axis of symmetry.

23. The method of claim 21 wherein the second opening is a vertically symmetric opening, wherein the opening is defined as the quantity
$${ⅇ}^{- {[ \frac{2 ( x - {x}_{in} )}{0.9 \cdot L} ]}^{24}}$$
multiplied by a scale factor reflected about the axis of symmetry.

24. A method for writing a chirped Bragg grating in an optical waveguide comprising the steps of:
providing an optical waveguide having a photosensitive core region disposed along the optical axis of the optical waveguide;
providing a light source;
providing a first shadow mask;
providing a lens;
altering the index of refraction of the photosensitive core region by exposing the photosensitive core region to light from the light source, wherein the light is directed onto the photosensitive core region by the lens after the light has passed through the first shadow mask, wherein the photosensitive core region is exposed to the light for a predetermined time;
providing a second shadow mask;
providing a phase mask; and
creating perturbations in the index of refraction of the photosensitive core region by exposing the photosensitive core region to light from the light source, wherein the light is directed onto the photosensitive core region by the lens after the light has passed through the second shadow mask, wherein after the light has passed through the lens the light passes through the phase mask, wherein the photosensitive core region is exposed to the light for a predetermined time.

25. The method of claim 24 wherein the light source is a laser.

26. The method of claim 25 where in the light is a laser beam having a uniform energy density.

27. The method of claim 26 wherein the first shadow mask modifies the cross sectional shape of the laser beam and does not modify the energy density of the laser beam.

28. A method for fabricating an apodized grating comprising the steps of:
providing an optical waveguide having a photosensitive core region disposed along the optical axis of the optical waveguide;
providing a light source;
providing a shadow mask;
providing a lens;
providing a phase mask; and
directing a beam of coherent light from the light source onto the photosensitive core region for a predetermined time, thereby writing an apodized grating in the optical waveguide,
wherein the step of directing light from the light source onto the photosensitive core region comprises the steps of
passing at least a portion of the beam of coherent light through an aperture in the shadow mask;
capturing the at least a portion of the beam of coherent light through an aperture in the shadow mask with a lens, wherein the lens focuses the at least a portion of the beam of coherent light onto the photosensitive core region after directing the at least a portion of the beam of coherent light through a phase mask.

29. The method of claim 28 wherein the opening is a vertically symmetric opening, wherein the opening is defined as the quantity
$${e}^{- {[ \frac{2 ( x - {x}_{m} )}{0.9 \cdot L} ]}^{24}}$$
multiplied by a scale factor reflected about the axis of symmetry.

30. The method of claim 28 wherein the opening is a vertically symmetric opening, wherein the opening is defined as the quantity
$$\frac{{sin}^{2} ( π x )}{{( π x )}^{2}}$$
multiplied by a scale factor reflected about the axis of symmetry.

31. The method of claim 28 wherein the opening is a vertically symmetric opening, wherein the opening is defined as the quantity e^{-ax}^{ⁿ} multiplied by a scale factor reflected about the axis of symmetry.

32. The method of claim 31 wherein n is an integer.

33. The method of claim 31 wherein n is 4.

34. The method of claim 31 wherein n is 6.

35. A method for changing the index of refraction of a photosensitive optical waveguide comprising the steps of:
providing a optical waveguide having a photosensitive core;
providing a first shadow mask, wherein said first shadow mask defines a first opening;
providing a lens;
aligning the lens, the shadow mask and the photosensitive core one to another;
directing a beam of light onto the first shadow mask, wherein at least a portion of the beam of light passed through the first opening and is focused by the lens onto the photosensitive core, wherein the photosensitive core is exposed to the beam of light for a predetermined length of time;
providing a second shadow mask, wherein the second shadow mask defines a second opening, wherein the second opening is the geometric inverse of the first opening;
replacing the first shadow mask with the second shadow mask; and
directing a beam of light onto the second shadow mask, wherein at least a portion of the beam of light passed through the first opening and is focused by the lens onto the photosensitive core, wherein the photosensitive core is exposed to the beam of light for a predetermined length of time.
